(19) United States
(12) Patent Application Publication
(10) Pub. No.: US 2010/0087304 A1
(43) Pub. Date: Apr. 8, 2010

(54) MATERIALS FOR AND METHOD FOR MANUFACTURING CONTAINER WITH END SUPPORTS AND RESULTING CONTAINER

(75) Inventor: Troy LITTLE, Thomasville, PA (US)

Correspondence Address: BARNES & THORNBURG LLP, 750-17TH STREET NW, SUITE 900, WASHINGTON, DC, 20006-4675, US

(73) Assignee: YORK CONTAINER COMPANY, York, PA (US)

(21) Appl. No.: 12/352,196

(22) Filed: Jan. 12, 2009

Related U.S. Application Data
(63) Continuation-in-part of application No. 12/247,473, filed on Oct. 8, 2008.
Application No. 12/247,473 is a continuation-in-part of application No. 12/268,594, filed on Nov. 11, 2008.
(60) Provisional application No. 61/119,076, filed on Dec. 2, 2008.

(51) Int. Cl. B31B 49/02; B65D 5/42; B65D 5/48

(52) U.S. Cl. 493/89; 493/90; 229/122.32; 229/120.33; 229/100

(57) ABSTRACT

In accordance with the invention, a method of manufacturing containers such as shipping, display and display ready packaging, for example, and resulting containers and associated preassemblies and blanks are provided, which, when utilized, result in preassemblies that include end supports that provide increased stacking strength and are easily and quickly assembled into fully assembled containers.

This application is a Continuation-in-Part of U.S. patent application Ser. No. 12/247,473, filed on Oct. 8, 2008; this application is also a Continuation-in-Part of U.S. patent application Ser. No. 12/268,594, filed on Nov. 11, 2008; and this application also claims the benefit of U.S. Provisional Patent Application No. 61/119,076, filed on Dec. 2, 2008, the entirety of which are being incorporated herein by reference in their entirety. The invention relates in general to the manufacture of packaging/containers that may be readily used to transport product and/or display the contents of the containers following delivery, as specified in the independent claims.

### BACKGROUND OF THE INVENTION

Various containers are conventionally provided as packaging for shipping or for display of product in a retail environment to prospective customers. As is conventionally known in the industry, such containers can be transported to manufacturing and/or retail environments for use in shipping or display in knock-down form, i.e., flattened but otherwise being glued, stapled or otherwise secured together, such that they are already substantially pre-assembled. Such knock-down form containers are also referred to as preassemblies. In such a “knockdown” state (i.e., knocked down or not set-up), personnel or equipment used in the final assembly of the product container need only open the sides and or ends of the container and affix the package bottom wall into its assembled condition. As a result, such container assembly may be performed such that the product can be placed into a resulting assembled container for shipping or as a display package.

Conventionally, it has been deemed advantageous at times to stack a plurality of such containers, one on top of the other for the purposes of storage, transport to a retail or manufacturing environment or during display in the retail environment. In these uses, it is necessary that the containers stacked above the bottom-most package are amply supported. Additionally, it is useful if the design of the containers is such that a stack of such containers, when filled with product, will not collapse.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with illustrated embodiments, a method of manufacturing containers and resulting containers and associated preassemblies and blanks are provided, which, when utilized, result in containers having an interior formed by a primary blank serving as an exterior of the container, the interior including a plurality of end supports, each of which being formed by a supplementary blank adhered to the primary blank at opposing ends of the container interior; the plurality of end supports are each formed as part of the set up or final assembly of exterior of the container.

Additionally, in accordance with at least one illustrated embodiment, the plurality of end supports are each formed by coupling of the primary blank with each of the supplementary blanks to at least one side panel and either an adjacent end panel or an opposing side panel of the primary blank.

Alternatively, in accordance with at least one illustrated embodiment, the plurality of end supports are each formed by coupling of the primary blank with each of the supplementary blanks to at least one end panel of the primary blank.

Further, the illustrated embodiments provide end supports with significantly less material than is conventionally required for similar conventional containers with auxiliary stacking supports. As a result, the amount of material incorporated in container designs utilizing the inventive concept may be reduced significantly in comparison to what is conventionally required to provide similarly robust containers. This reduction in material results in a reduction in the container weight and resources expended to produce the container, while still providing improved container strength; moreover, the reduction in container weight also reduces the amount of resources required to transport the container in preassembly and finally assembled and packed states.

The illustrated embodiments of the invention have particular utility when used for the manufacture of preassemblies and associated containers that are slotted bottom tray type containers.

These illustrated embodiments are achieved by a combination of features recited in the independent claims. Accordingly, dependent claims prescribe further detailed implementations of the present invention.

### BRIEF DESCRIPTION OF THE DRAWINGS

Various embodiments are described herein, by way of example only, with reference to the accompanying drawings. With specific reference now to the drawings, it should be understood that the particulars shown are by way of example and for purposes of discussion of illustrated embodiments only, and are presented in order to provide what is believed to be a useful and readily understood description of the principles and concepts of the invention. In this regard, no attempt is made to show structural details of the invention in more detail than is necessary for a fundamental understanding of the invention, the description taken with the drawings making apparent to those skilled in the art how the several forms of the invention may be embodied in practice.

Accordingly, a more complete understanding of the present invention and the utility thereof may be acquired by referring to the following description in consideration of the accompanying drawings, in which like reference numbers indicate like features, and wherein:

FIG. 1 illustrates a side perspective view of a container manufactured in accordance with an illustrated embodiment.

FIG. 2 illustrates an example of a primary blank used in manufacturing the container of the type illustrated in FIG. 1.

FIG. 3 illustrates an example of a supplementary blank used in manufacturing the container of the type illustrated in FIG. 1.

FIG. 4 illustrates the pre-assembly materials for the container of the type illustrated in FIG. 1 in a first stage of pre-assembly.

FIG. 5 illustrates the pre-assembly materials for the container of the type illustrated in FIG. 1 in a second stage of pre-assembly.

FIG. 6 illustrates the pre-assembly materials for the container of the type illustrated in FIG. 1 in a third stage of pre-assembly.

FIG. 7 illustrates a top view of the package illustrated in FIG. 1.

FIG. 8 illustrates a manufacturing methodology provided in accordance with the claimed invention.

FIG. 9 illustrates a side perspective view of a container manufactured in accordance with another illustrated embodiment.

FIG. 10 illustrates an example of a primary blank used in manufacturing the container of the type illustrated in FIG. 9.

FIG. 11 illustrates an example of a supplementary blank used in manufacturing the container of the type illustrated in FIG. 9.

FIG. 12 illustrates the pre-assembly materials for the container of the type illustrated in FIG. 9 in a first stage of pre-assembly.

FIG. 13 illustrates the pre-assembly materials for the container of the type illustrated in FIG. 9 in a second stage of pre-assembly.

FIG. 14 illustrates the pre-assembly materials for the container of the type illustrated in FIG. 9 in a third stage of pre-assembly.

FIG. 15 illustrates a top view of the package illustrated in FIG. 9.

FIG. 16 illustrates a side perspective view of a container manufactured in accordance with another illustrated embodiment.

FIG. 17 illustrates an example of a primary blank used in manufacturing the container of the type illustrated in FIG. 16.

FIG. 18 illustrates an example of a supplementary blank used in manufacturing the container of the type illustrated in FIG. 16.

FIG. 19 illustrates the pre-assembly materials for the container of the type illustrated in FIG. 16 in a first stage of pre-assembly.

FIG. 20 illustrates the pre-assembly materials for the container of the type illustrated in FIG. 16 in a second stage of pre-assembly.

FIG. 21 illustrates the pre-assembly materials for the container of the type illustrated in FIG. 16 in a third stage of pre-assembly.

FIG. 22 illustrates a top view of the package illustrated in FIG. 16.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Shipping, display and dual-use containers (e.g., those containers that may be used for both shipping and display), often suffer from a conventional problem in that product in the containers can shift during shipping or during display. This is a particular problem when product is susceptible to shifting, slipping, sliding or otherwise moving upon itself. It is particularly useful to inhibit such movement if, for example, the product is fragile or the product is at risk of moving out of an aperture in the container.

Further, as explained above, it is useful to be able to stack a plurality of containers one on top of the other for the purposes of transport to or from a manufacturing or retail environment or during storage and/or display in a manufacturing or retail environment. This ability (also known as “stackability”) requires that containers stacked above the bottom-most package are amply supported and also requires that a stack of a number of such containers, when filled with product, will not collapse.

Conventionally, there are various container designs that provide increased stackability by including, for example, types of corner supports or auxiliary supports that utilize additional material and components to increase the vertical stability of the container. However, the number of separate actions needed to assemble such container designs (conventionally referred to as the number of “touches” required for assembly) varies greatly and may be significant; thus, a container requiring complex assembly requires a greater number of touches than a container requiring relatively simple assembly.

The skill level and time required for assembling such containers from a knock-down form varies depending on the required number of touches for assembling the container. The time required for assembling conventional container including such auxiliary supports of some sort or another may be somewhat lengthy as assembly of a container may require a number of separate actions to be performed by the final container assembler (regardless of whether the final assembly is performed by a human or automated or semi-automated machinery).

Another problem with such conventional, stackable container designs is the increased height, length, width and weight of such containers due to the added material provided for the auxiliary supports. Alternatively, where the designs' outer dimensions are not increased, the amount of space taken up by the added material reduces the capacity of the container. Therefore, although the use of such stackable containers is useful, the increased time for final assembly and increased dimensions and weight of the containers are deficiencies of conventional designs.

Thus, there is a need for a stackable container design that can deter movement of product packaging therein and provides some type of auxiliary support that results in reduced affect on the overall dimensions and weight of the container, while both reducing the amount of material used in the container and reducing the number of touches required for final assembly of the container.

With this understanding in mind, a description of various invention embodiments is now provided.

According to at least one illustrated embodiment, there is provided equipment configured to manufacture containers, e.g., for shipment and/or display of product (as well as corresponding container preassemblies and blanks) that result in containers having an interior formed by a primary blank serving as an exterior of the container, the interior including a plurality of end supports each formed by a supplementary blank adhered to the primary blank. In accordance with illustrated embodiments, the plurality of end supports are each formed by coupling of the primary blank with each of the supplementary blanks at at least one side panel and, optionally, at least one end panel of the primary blank. In accordance with at least one embodiment, the plurality of end supports are formed as part of the set up or final assembly of exterior of the container.

Understanding of the manufacturing of a container, blanks and/or preassemblies in accordance with embodiments may best be understood by first reviewing an illustration of a manufactured container provided in accordance with one illustrated embodiment.

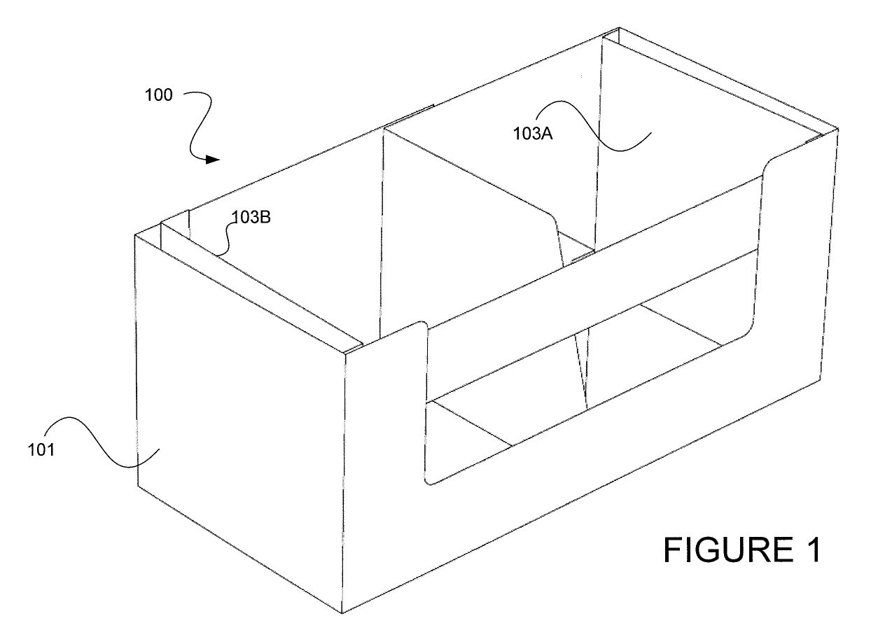

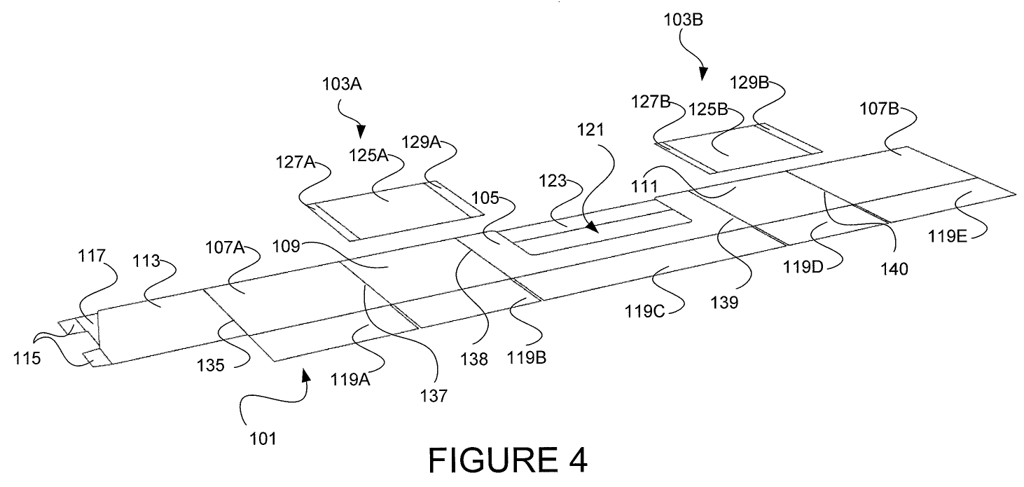

As illustrated in FIG. 1, one example of such a container 100 may be a slotted bottom tray style container formed by a primary blank 101. The container 100 may include an interior defined between by the side walls of the primary blank 101 and a plurality of end supports formed by a corresponding plurality of supplementary blanks 103 (illustrated as part of the container as 103A-B), included in the interior of the primary blank 101 following assembly. These end supports may be formed by the coupling of the supplementary blanks 103A-B to locations on the primary blank 101, as explained herein. Additionally, as part of preassembly manufacture for a preassembly for container 100, the supplementary blanks 103A-B may be adhered to the primary blank 101 as explained in connection with FIGS. 4-6 to provide for improved ease of final assembly for the container 100.

As shown in FIG. 1, each of the end supports may span the entire corresponding end walls of the container 100. Such a container 100 may be used for various purposes including shipping and/or display on a display floor along with other such containers in a stack. However, it should be understood that the manufactured container may be any type of container including, for example, any carton, package, box, etc., of any suitable type; accordingly, the actual configurations of the primary blank 101 and the interrelationship with the supplementary blanks 103A, 103B may change without departing from the scope of the embodiments. Thus, in accordance with illustrated embodiments, a method is provided of manufacturing containers and resulting containers 100 and associated preassemblies (the combination of 101, 103A, 103B) and blanks 101, 103 (supplementary blank 103 being the blank that forms each of 103A, 103B when joined with primary blank 101); when utilized, the method result in containers 100 that include supplementary blanks 103A, 103B that each provide an end support that serves as a mechanism for improving the stackability of the container 100, whereby the container 100 may be configured to bare larger amounts of force (e.g., weight) from a top direction.

Based on the illustrated examples of container designs provided with end supports as disclosed herein, it should be appreciated that the incorporation of the end supports increases stackability of the resulting containers without requiring a lengthier time period for final assembly and without a need for assemblers (either human or automated or semi-automated equipment) to have superior capabilities. This is because, as explained herein, the majority if not all of manipulation of the preassembly to form the end supports is already performed as part of the final assembly of the primary blank as the exterior of the container. As a result, additional touches needed to provide the end supports is reduced or eliminated relative to what would be conventionally required for installing or assembling conventional auxiliary stacking supports.

Further, as mentioned above, the illustrated examples of container designs provide end supports with significantly less material than is conventionally required for similar conventional containers with auxiliary stacking supports. For example, the square footage of material incorporated in container designs utilizing the inventive concept may be reduced significantly. This reduction in material results in a reduction in the container weight and resources expended to produce the container, while still providing improved container strength.

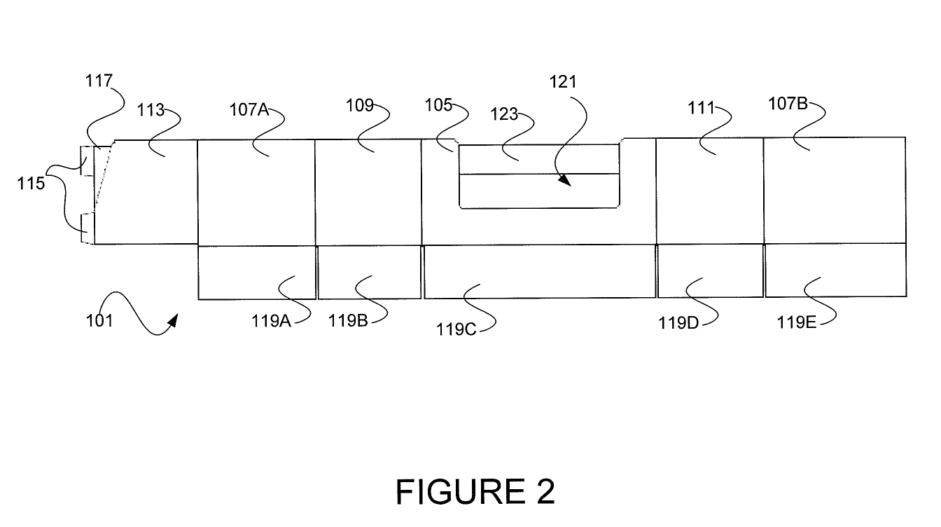

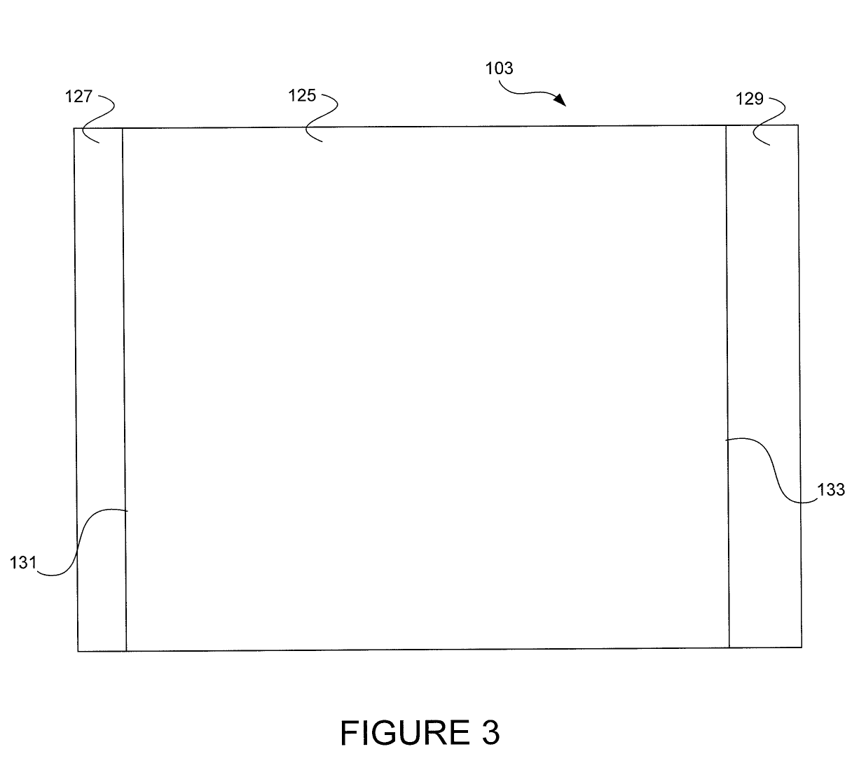

FIG. 2 illustrates an example of a primary blank 101, which may be thought of as a conventional tray type as the one illustrated in FIG. 1. The knockdown of the container 100 of FIG. 1 is manufactured by joining the primary blank 101 with supplementary blanks 103A, 103B (which may be thought of as pads) an example of which being illustrated in FIG. 3, as explained herein. The primary blank 101 illustrated in FIG. 2 corresponds to an exterior of the container 100 illustrated in FIG. 1. Likewise, the container 100 also includes supplementary blanks 103A, 103B, which are each formed using supplementary blank 103 illustrated separately in FIG. 3 (and in conjunction with primary blank 101 in FIGS. 4-7).

As shown in FIG. 2, the primary blank 101 includes a front side panel 105 and two back side sub-panels 107A, 107B that cooperate to form a back side of the container. The primary blank also includes a first end panel 109 and a second end panel 111. Each of the aforementioned side panels are coupled to corresponding bottom panels 119A-E; these bottom panels 119A-E cooperate as part of final assembly of the container 100 to form a bottom of the container 100.

The front side panel 105 includes an optional aperture 121, which may be formed during manufacture of the blank 101 or may result from removal of a scored section included in front side panel 105. Further, front side panel 105 may optionally include a cross member 123 that is provided to assist in ensuring that container contents remain within the interior of the container when the aperture 121 is present in the container while the container is functioning as a shipping container. Additionally, the cross member 123 provides some degree of stability to the front side panel 105 when the optional aperture 121 is included.

The cross member 123 may be removable from the front side panel 105 as a scored section; in this way the cross member 123 may be removed following delivery of the container 100 to a retail environment so that the container 100 may be used as a display container with the aperture 121 providing viewing and access to contents of the container 100. Further, although not illustrated in any of the figures, it should be appreciated that the containers provided in accordance with the disclosed embodiments may include one or more top panels that provide a top of the container. Thus, in the same way that a scored, tear-away portion of the front side panel 105 may be removed for to reconfigure the container as a display container, so may the one or more top panels be removed to provide access to the contents of the container.

Also included in the primary blank 101 is an optional divider panel 113 coupled to one of the back side sub-panels 107A. When the primary blank 101 is finally assembled as part of the container 100, the divider panel 113 is placed parallel to the first and second end panels 109, 111 and affixed to the front side panel 105. More specifically, the divider panel 113 is affixed in this way using one or more attachment panels 115 coupled to the divider panel by a mid-panel 117. The mid-panel 117 serves to provide additional support for the cross member 123 by coupling the cross member 123 to the optional divider panel 113. Thus, in such a design, during reconfiguration of the container from a shipping container to a display container, the mid-panel 117 and the cross member 123 may be removed.

FIG. 3 illustrates an example of the supplementary blank 103 used in manufacturing the container of the type illustrated in FIG. 1. The supplementary blank 103 includes a major panel 125 as well as two adjacent attachment panels 127, 129. As shown in FIG. 3, a first attachment panel 127 shares a fold line 131 with the neighboring major panel 125. Likewise, a second attachment panel 129 shares a fold line 133 with the neighboring major panel 125.

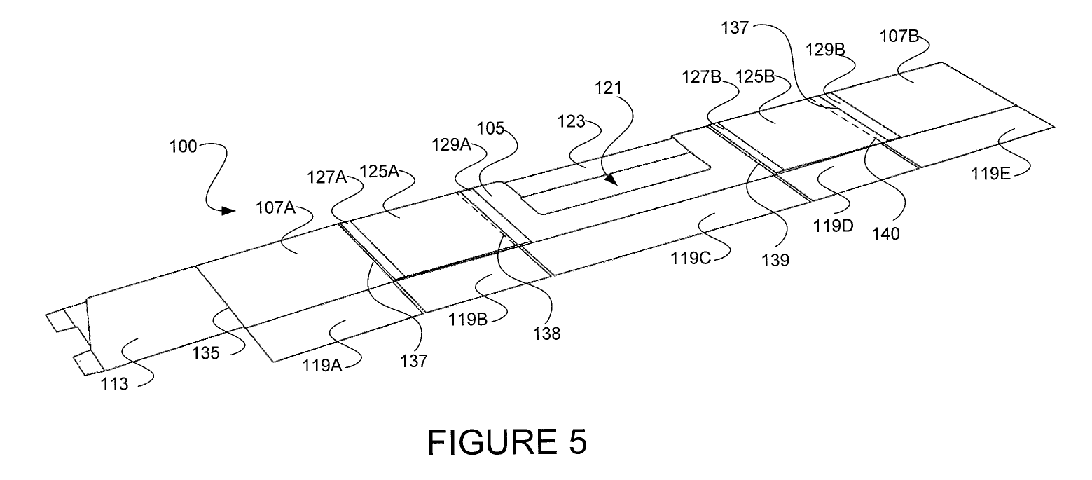

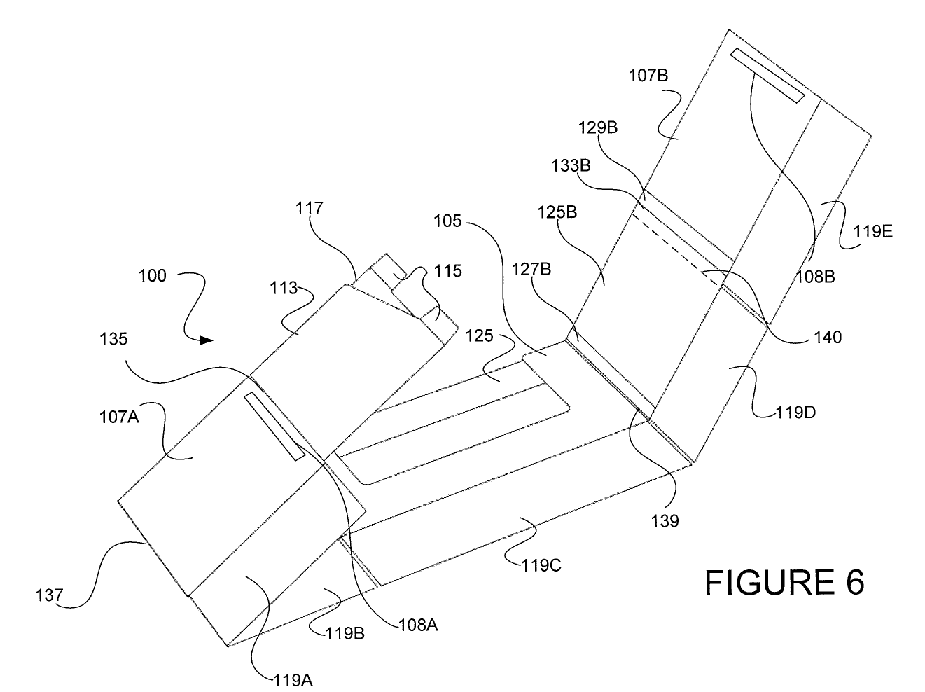

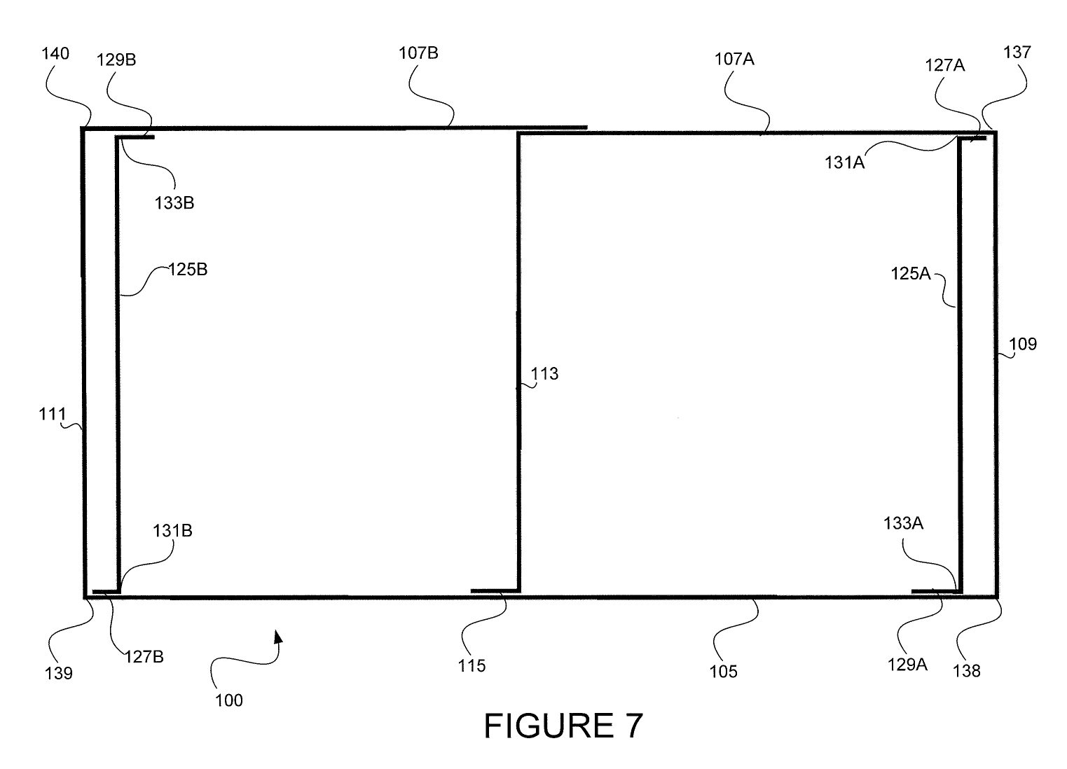

FIG. 4 illustrates the relative placement of the primary blank 101 and supplementary blanks 103 illustrated in FIGS. 2 and 3 with respect to each other to provide a preassembly as illustrated in FIGS. 5-6 and the container illustrated in FIGS. 1 and 7. It should be understood that the supplementary blank 103 illustrated in FIG. 3 is the same blank as 103A and 103B illustrated in FIGS. 1 and 4-7 but is labeled as such for ease of description. Thus, where a blank 103 (illustrated in FIG. 3) includes a main panel 125 and two attachment panels 127, 129, the supplementary blank 103A (illustrated in FIGS. 4-7) includes a main panel 125A and two attachment panels 127A, 129A; likewise the supplementary blank 103B (illustrated in FIGS. 4-7) includes a main panel 125B and two attachment panels 127B, 129B.

As illustrated in FIG. 4, the primary and supplementary blanks 101, 103A, 103B may be configured so as to interact in a manner that enables the end supports to be formed easily and quickly as part of the final assembly of the container 100 from a corresponding preassembly (also referred to, for convenience, as preassembly 100). Accordingly, the dimensions for the blanks 101, 103A, 103B and their constituent panels, walls and sections may be selected so as to facilitate the positioning of the supplementary blanks 103A, 103B with respect to the primary blank 101 as illustrated in FIG. 4. The relative dimensions of certain panels of the primary blank 101 and supplementary blanks 103A, 103B are discussed further with reference to FIGS. 5-6.

As mentioned above and will be further appreciated from the remaining disclosure by one of ordinary skill in the art, the container 100 may be used to ship, store or display product therein in a retail environment. Thus, subsequent to arrival at a retail environment or off-site fulfillment or contract packaging facility, a knockdown version of the container 100 (i.e., preassembly 100) may be finally assembled and product placed in the container 100 for transport and/or display. Therefore, it should be appreciated that, as a first operation in manufacturing the preassembly for the container 100, the faces of the primary blank 101 and supplementary blanks 103A, 103B may be affixed together at various locations.

Thus, as shown in FIG. 4, a preassembly may be provided wherein the primary blank 101 and supplementary blanks 103A, 103B are adhered to one another via adhesive but the panels, walls, etc. are not configured for final assembly. As a result, a preassembly 100 (such as that illustrated in FIG. 5) may be manufactured and may be delivered to a location for final assembly and placement of product; such a preassembly may be effectively and easily stacked with other preassemblies because such preassemblies are flat having not yet been built or finally assembled as shown in FIG. 1.

Thus, returning to the manufacture of the preassembly, one or more portions of the primary blank 101 and supplementary blanks 103A, 103B may be adhered to one another. Thus, for example, adhesive may be provided on the underside of the attachment panel 129A of the supplementary blank 103A; likewise adhesive may be provided on the underside of the attachment panel 129B of the supplementary blank 103B. Additionally, adhesive may be provided on the top side of the attachment panel 127A of the supplementary blank 103A and the top side of the attachment panel 127B of the supplementary blank 103B. This alternating placement of adhesive for the two supplementary blanks 103A-B enables the supplementary blanks to be properly erected into the end supports when the container is finally assembled.

Thus, when primary blank 101 is brought into contact with the supplementary blanks 103A, 103B, the blanks are joined. It should be understood that this coupling may be made using, for example, adhesive such as glue, staples, tape, etc., so as to produce the preassembly, wherein the positioning of supplementary blanks 103A, 103B in cooperation with primary blank 101 is controlled.

More specifically, and with reference to FIGS. 4-5, the attachment panel 127A is positioned over the first end panel 109 with the outer edge of the attachment panel 127A being positioned next to and parallel with the fold line 137 between the first back side sub-panel 107A and the first end panel 109. The attachment panel 127A is adhered to the first back side sub-panel 107A because the adhesive is applied to the top side of the attachment panel 127A and the first back side sub-panel 107A is folded over to lay on top of the attachment panel 127A.

Because of the combined width dimensions of the attachment panel 127A and the major panel 125A, the positioning results in the fold line 133A of the supplementary blank being located past the fold line 138 provided between the first end panel 109 and the front side panel 105 of the primary blank. Thus, the entirety of the attachment panel 129A and the fold line 133A are provided on top of the front panel 105 offset from the fold line 138 of the primary panel.

Likewise, the attachment panel 127B is positioned to over the second end panel 111 with the outer edge of the attachment panel 127B being positioned next to and parallel with the fold line 139 between the front side panel 105 and the second end panel 111. The attachment panel 127B is adhered to the second end panel 111 because the adhesive is applied to the top side of the attachment panel 127B and the top side of the attachment panel 127B is folded over to contact the second end panel 111.

Because of the combined width dimensions of the attachment panel 127B and the major panel 125B, the positioning results in the fold line 133B of the supplementary blank being located past the fold line 140 provided between the second end panel 111 and the second back side sub-panel 107B of the primary blank. Thus, the entirety of the attachment panel 129B and the fold line 133B are provided on top of the second back side sub-panel 107B offset from the fold line 140 of the primary panel.

As explained in more detail with reference to FIGS. 6-7, the fold lines 131A-B, 133A-B of the supplementary blanks are positioned parallel to but spaced away from corresponding fold lines 137-140 on the primary blank 101 to promote ease of final assembly, increase stacking strength and deter nesting of containers resulting from poor stacking strength.

As shown in FIGS. 4-5, the primary and supplementary blanks may be adhered to each other to form a preassembly 100, where the attachment panels 127A-B, 129A-B of the supplementary blanks meet mating portions of the corresponding panels of the primary blank. More specifically, attachment panel 127A is adhered to the first back sub-panel 107A, the attachment panel 129A is adhered to the front side panel 105, the attachment panel 127B is adhered to the front side panel 105 and the attachment panel 129B is adhered to the second back sub-panel 107B.

These panels may be adhered to one another, for example, using adhesive that may be applied to attachment panels 127A-B, 129A-B of each of the supplementary blanks and/or portions of the corresponding panels of the primary blank. Subsequently, the attachment panels 127A-B, 129A-B of each of the supplementary blanks may be placed in contact with corresponding portions of the panels of the primary blank to promote adherence therebetween.

As mentioned above, the fold lines 131A-B, 133A-B of the supplementary blanks are positioned parallel to but spaced away from corresponding fold lines 137-140 on the primary blank 101 to promote ease of final assembly, increase stacking strength and deter nesting of containers resulting from poor stacking strength. Thus, the fold line 131A on a first supplementary blank corresponds to but is positioned next to the fold line 137 between the first back sub-panel 107A and the first end panel 109. Likewise, the fold line 133A on the first supplementary blank corresponds to but is spaced apart from the fold line 138 between the first end panel 109 and the front side panel 105. Further, fold line 131B on the second supplementary blank corresponds to but is positioned next to fold line 139 between the second end panel 111 and the front side panel 105. Likewise, the fold line 133B on the second supplementary blank corresponds to but is spaced apart from the fold line 140 between the front side panel 105 and the second end panel 111. Thus, the fold lines of the supplementary blanks and the corresponding fold lines on the primary blank are positioned parallel to one another but spaced away from each other.

The relationship between the fold lines of the primary and supplementary blanks 101, 103 may be even more clearly understood with reference to FIG. 6. FIG. 6 illustrates the pre-assembly materials for the container of the type illustrated in FIG. 1 during pre-assembly manufacture. The offset of the fold lines of the primary and supplementary blanks enables the preassembly 100 to be flat for shipping to a final assembly location as well as being simply assembled to provide the end supports during final assembly. More specifically, as shown in FIG. 6, as part of preassembly manufacture, the first back sub-panel 107A is folded towards the first end panel 109 along fold line 137. As a result, the optional divider panel 113 (coupled to the first back sub-panel 107A at fold line 135 illustrated in FIGS. 4-5) is carried along towards the front side panel 105. Likewise, the second end panel 111 (not shown but illustrated in FIGS. 5-6) together with the first attachment panel 127B and major panel 125B are folded towards the front side panel 105 along fold line 139. As a result, the second back sub-panel 107B is carried along towards the front side panel 105. To facilitate joining of one end of the optional divider panel 113 to the front side panel 105, adhesive is provided either on the underside of the attachment panels 115 or on a corresponding mating surface on the front side panel 105 (e.g., in a center region of the front side panel 105 and its constituent cross member 123). Although not shown, the first back sub-panel 107A and the divider panel 113 are then positioned to lay flat on top of the corresponding first end panel 109 and first back sub-panel 105.

Additionally, adhesive is applied to either or both an adhesion region 108A on first back sub-panel 107A or a corresponding adhesion region 108B which is provided on a corresponding mating surface of the second back sub-panel 107B. Thus, once the first back sub-panel 107A is lying flat on top of the first end panel 109 (not shown in FIG. 6), the second back sub-panel 107B is positioned on top of the first back sub-panel 107A but offset in a lateral direction so that the regions 108A and 108B are aligned with one another. As a result of this positioning and affixing of the primary and supplementary blanks described with reference to FIGS. 1-6, a preassembly 100 may be provided which, when utilized, results in a container 100 having an interior formed by the primary blank 101 serving as an exterior of the container 100. The interior includes a plurality of end supports each formed by the supplementary blanks 103A-B and positioned at opposing ends of the container interior, wherein the plurality of end supports are formed as part of the set up or final assembly of exterior of the container 100.

As illustrated in FIG. 7, the resulting container 100 includes the first and second end panels 109, 111, the front side panel 105 and a back side panel formed by the two back side sub-panels 107A-107B. The supplementary blanks adhered to the primary blank provide the end supports on opposing ends of the container 100, wherein each end support is formed by the major panel 125A, 125B, positioned parallel to but spaced apart from their corresponding end panels 111, 109. This offset in positioning deters nesting of the container 100 when the container is used in a stack of containers and being exposed to great vertical force.

The offset of the fold line 131A from the fold line 137 as well as the corresponding offsets provided between fold line pairs (133A, 138), (131B, 139) and (133B, 140) provides the additional utility of enabling improved ease of opening the preassembly to form the container with the end supports. More specifically, when the panels 105, 107A-B, 109, 111 are manipulated to begin formation of the interior of the container 100 there between, the relative dimensions of those panels and those of the supplementary blank panels (125A-B, 127A-B, 129A-B) force the main panels 125A-B to be positioned parallel to the end panels 109, 111, with little or no additional manipulation or force. Thus, it should be appreciated that, the installation of the end supports including the main panels 125A-B may be automatic as a result of the assembly of the panels of the primary blank 101 or it may be facilitated by some minimal additional force.

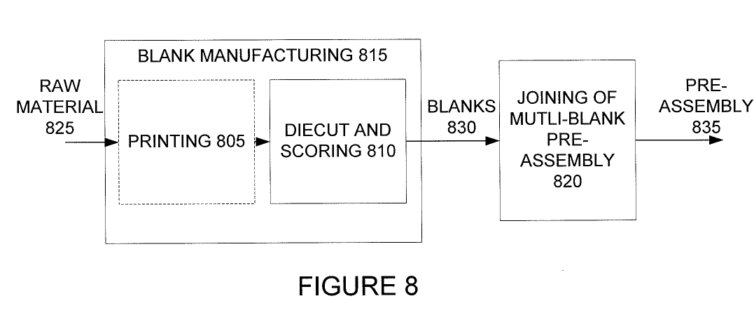

With this understanding of the utility of the invention in mind, FIG. 8 illustrates a functional block diagram used to describe the manufacturing method of containers in accordance with an illustrated embodiment. As alluded to in the background section, and as conventionally known, the manner of manufacturing containers such as the examples illustrated in FIGS. 1-7 may be conveniently described in two phases: preassembly and final assembly/use.

Preassembly manufacture, as described in connection with FIGS. 3-6, is normally performed at a container manufacturing facility to produce a preassembly which may also be thought of and referred to as a knockdown of the container. These preassemblies may be shipped to a customer location such as a product manufacturing facility or retail environment or third party fulfillment contract packaging facility. At that destination, the container customer may perform final assembly of the containers by, for example, folding and assembling various panels, e.g., the bottom panels, of the container to provide a container that is configured to hold manufactured product, e.g., for shipping and/or display.

The manufacturing of the container preassemblies may be performed by the customer of the preassemblies and/or as part of manufacture of the preassemblies as illustrated in FIG. 8. FIG. 8 illustrates various functional operations performed as part of the manufacture of a preassembly by, for example, a display, shipping or display ready packaging manufacturer. The operations may begin, for example, with printing 805 of container material prior to the container material being die cut and/or scored 810 as part of an overall blank manufacturing operation 815. The manufactured blanks 830 may or may not be printed on one or both sides of the blanks 830 depending on customer requirements. Accordingly, the printing operation 805 may be omitted.

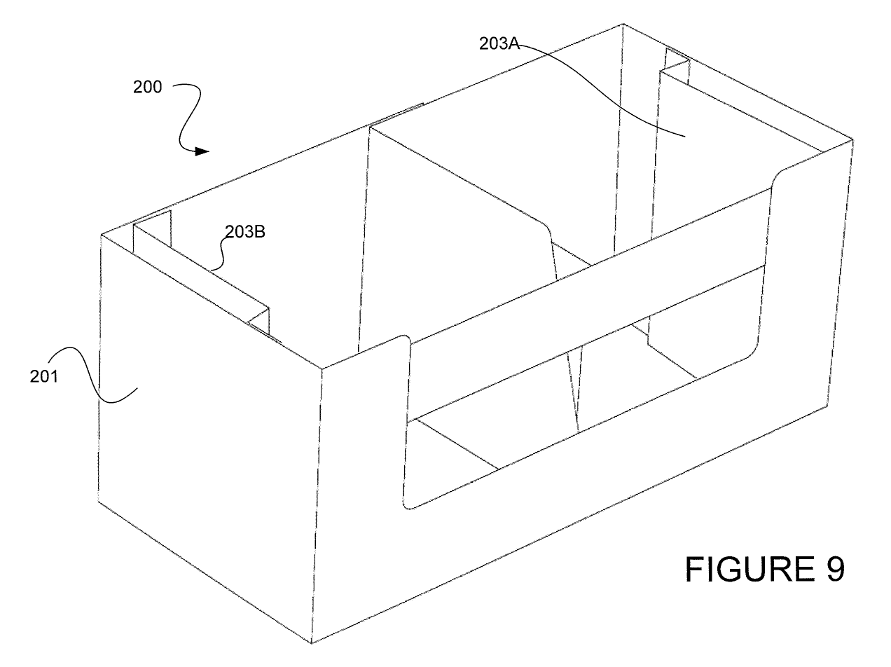

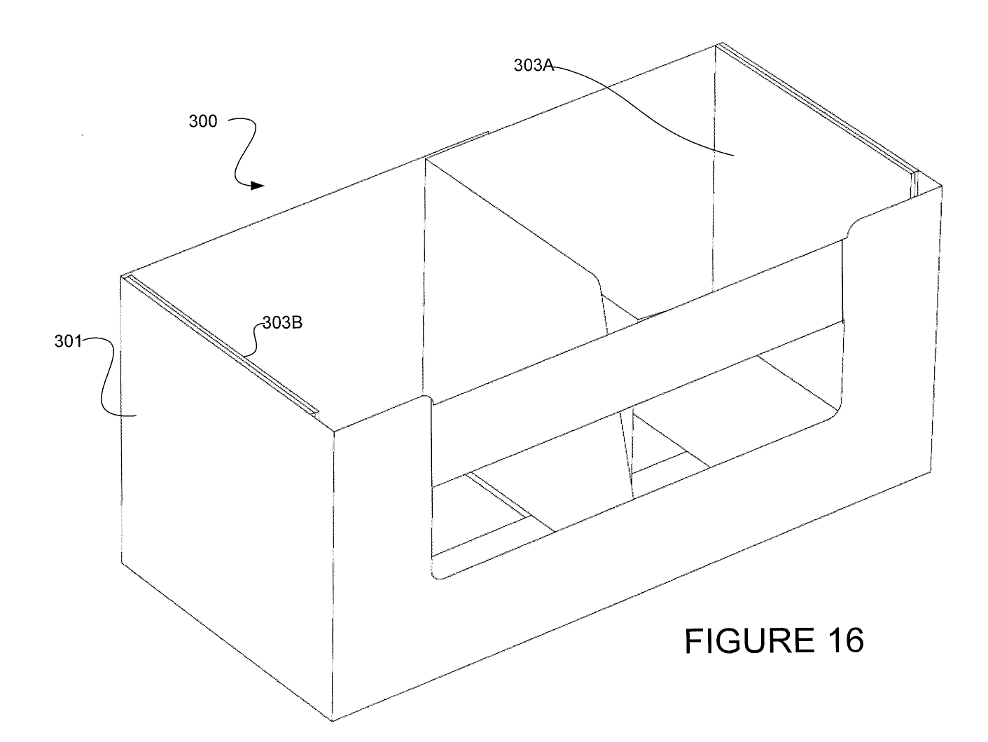

Subsequent to blank manufacturing 815, the manufactured blanks may be affixed to one another as part of the joining of multi-blank preassembly operations 820. The operations performed at 820 may be performed in various suitable manners including by hand or using various commercially available machines (for example, those produced by Bahmueller Technologies, Inc. of Charlotte, N.C., USA or Bobst Group North America of Roseland, N.J., USA). Thus, the operations performed at 820 may produce preassemblies for containers such as that illustrated in FIG. 1 (and also those illustrated in FIGS. 9 and 16).

Therefore, it should be appreciated that one or more of the operations performed to produce blanks, preassemblies, knockdowns and containers may be performed in whole or in part by machines and or human personnel. Moreover, human personnel may utilize one or more different types of machines and/or tools to perform assembly operations performed either to manufacture preassemblies or finally assembled containers.

Thus, at the beginning of such operations, raw material 825 is used to produce blanks 830. Such raw materials 825 may include but are not limited to various grades, types, configurations and combinations of corrugated fiberboard and/or solid paperboard, liner board, board of various fluting types and combinations as well as various types of sealants, non-organic materials and inks and dies of various suitable types.

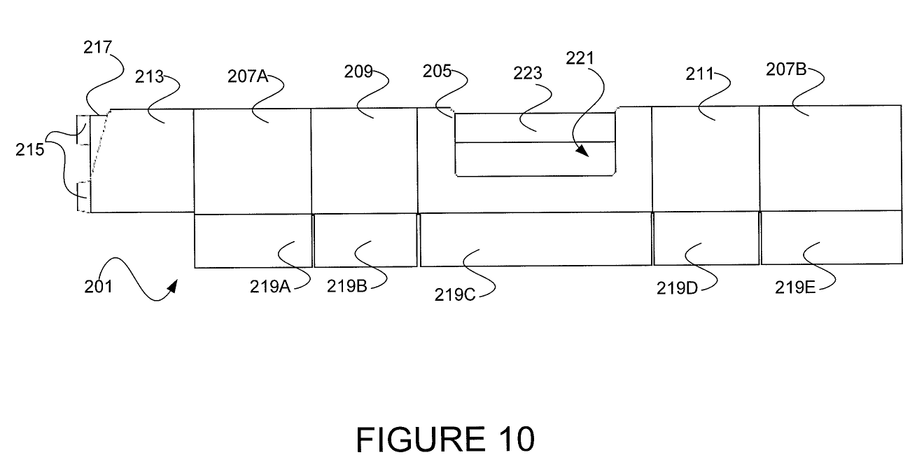

As mentioned above, it should be appreciated that the embodiment illustrated in FIGS. 1-7 is merely one implementation of a design provided according to the invention. Therefore, various other designs may be provided that include end supports in accordance with the invention embodiments. For example, FIG. 9 illustrates another example of such a container; container 200 is also a slotted bottom tray style container formed by a primary blank 201. The container 200 may include an interior defined between by the side walls of the primary blank 201 and a plurality of end supports formed by a corresponding plurality of supplementary blanks 203 (illustrated in place in the container as 203A-B), included in the interior of the primary blank 201 following assembly. These end supports may be formed by the coupling of the supplementary blanks 203A-B to locations on the primary blank 201, as explained herein. Additionally, as part of preassembly manufacture for a preassembly for container 200, the supplementary blanks 203A-B may be adhered to the primary blank 201 as explained in connection with FIGS. 10-14 to provide for improved ease of final assembly for the container 200.

As shown in FIG. 9, each of the end supports may span a majority of the corresponding end walls of the container 200. Such a container 200 may be used for various purposes including shipping and/or display on a display floor along with other such containers in a stack. However, it should be understood that the manufactured container may be any type of container including, for example, any carton, package, box, etc., of any suitable type; accordingly, the actual configurations of the primary blank 201 and the interrelationship with the supplementary blanks 203A, 203B may change without departing from the scope of the embodiments. Thus, in accordance with illustrated embodiments, a method is provided of manufacturing containers and resulting containers 200 and associated preassemblies (the combination of 201, 203A, 203B) and blanks 201, 203 (supplementary blank 203 being the blank that forms each of 203A, 203B when joined with primary blank 201); when utilized, the method result in containers 200 that include supplementary blanks 203A, 203B that each provide an end support that serves as a mechanism for improving the stackability of the container 200, whereby the container 200 may be configured to bare larger amounts of force (e.g., weight) from a top direction.

FIG. 10 illustrates an example of a primary blank 201, which may be thought of as a conventional tray type as the one illustrated in FIG. 1. It should be appreciated that the primary blank 201 is identical to primary blank 101 illustrated in FIG. 2 except with an alteration in the reference numerals, i.e., front panel 105 corresponds with front panel 205. Therefore, further description of the primary blank 201 is omitted.

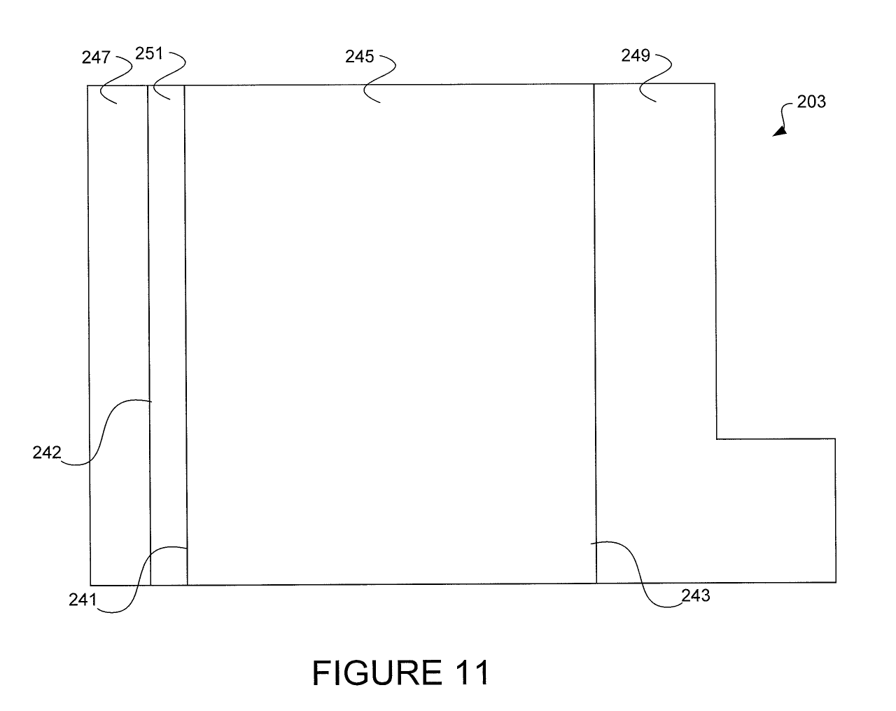

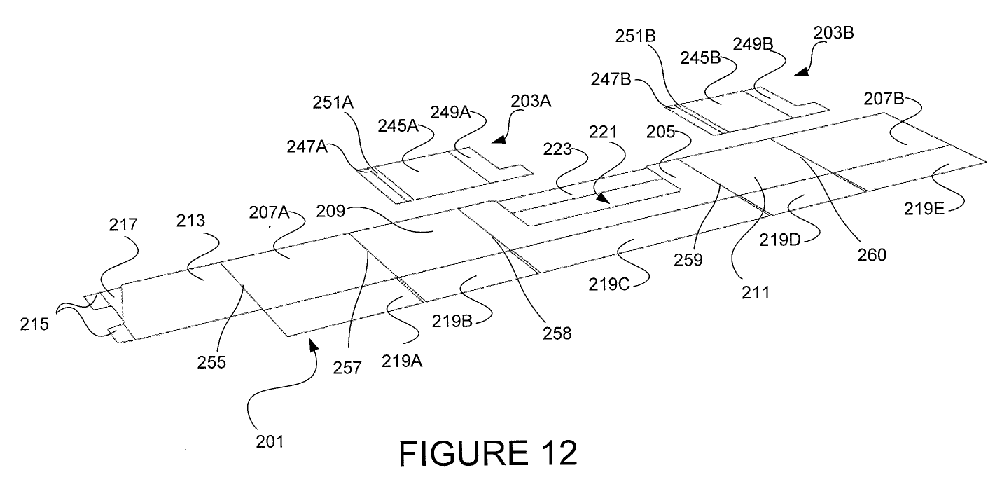

FIG. 11 illustrates an example of a supplementary blank 203 that differs in configuration from the supplementary blank 103 illustrated in FIG. 2. As shown in FIG. 11, the supplementary blank 203 includes a main panel 245 as well as two attachment panels 247, 249. As shown, attachment panel 249 may have an enlarged width dimension at its lower end, which may be optionally provided to further improve strength of the front side panel 205 following joint of the primary blank 201 and supplementary blanks. The supplementary blank 203 also includes an offset panel 251; when the supplementary blank 203 is joined with the primary blank 201 in the container 200, the offset panel 251 serves to enable an offset joining of the major panel 245 to the first or second end panels 209, 211, as explained herein with reference to FIGS. 12-14. As shown in FIG. 11, the offset panel 251 shares a fold line 241 with the main panel 245; likewise, the first attachment panel 247 shares a fold line 242 with the offset panel 251. Also, the second attachment panel 249 shares a fold line 243 with the neighboring major panel 245.

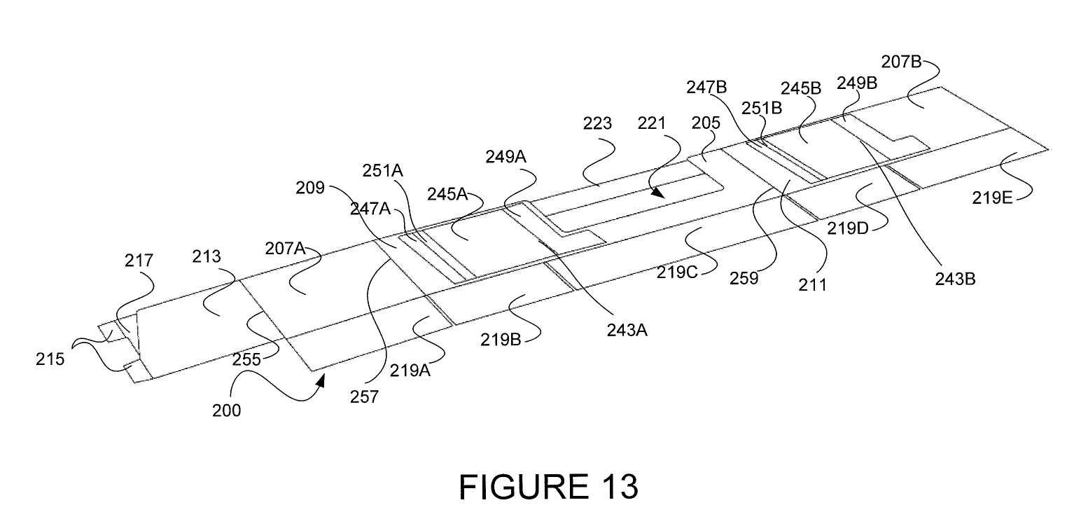

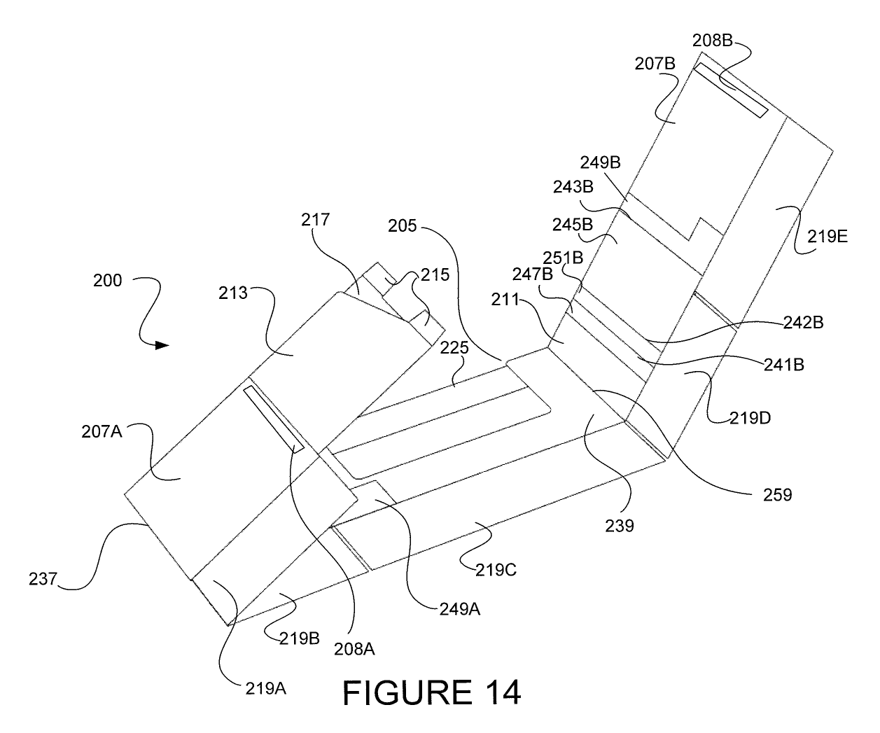

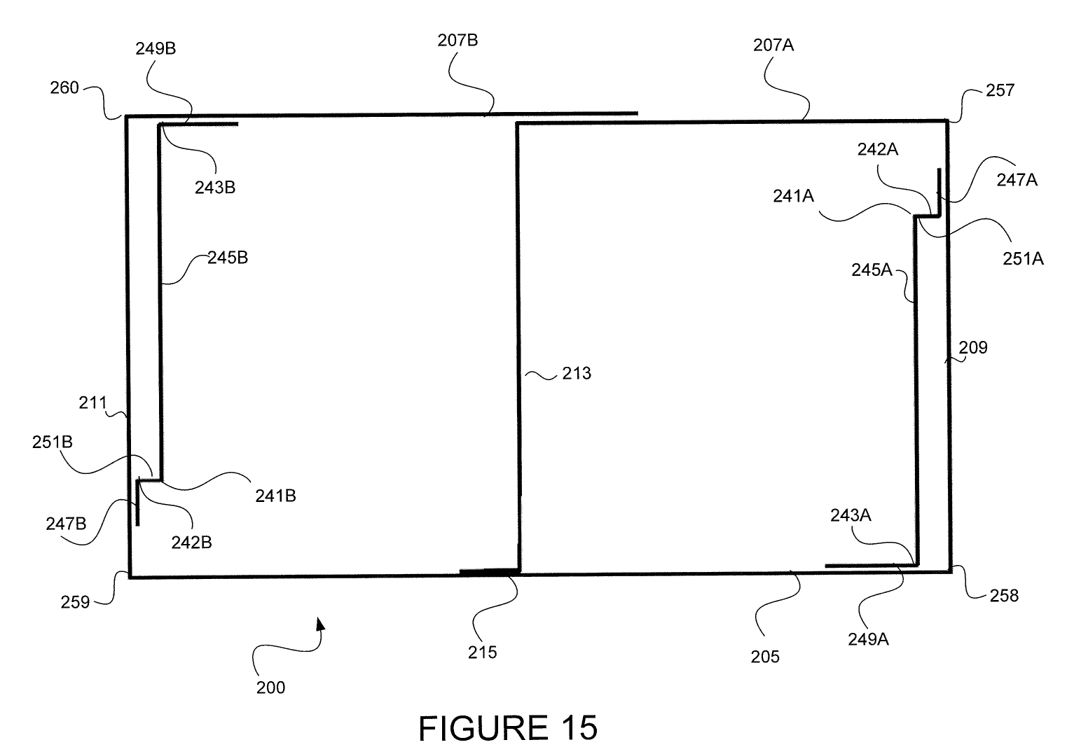

FIG. 12 illustrates the relative placement of the primary blank 201 and supplementary blanks 203 illustrated in FIGS. 10 and 11 with respect to each other to provide a preassembly as illustrated in FIGS. 13-14 and the container illustrated in FIGS. 9 and 15. It should be understood that the supplementary blank 203 illustrated in FIG. 11 is the same blank as 203A and 203B illustrated in FIGS. 9 and 12-15 but is labeled as such for ease of description. Thus, where a blank 203 (illustrated in FIG. 11) includes a main panel 245 and two attachment panels 247, 249, and an offset panel 251, the supplementary blank 203A (illustrated in FIGS. 12-15) includes a main panel 245A, two attachment panels 247A, 249A and an offset panel 251A; likewise the supplementary blank 203B (illustrated in FIGS. 12-15) includes a main panel 245B, two attachment panels 247B, 249B and an offset panel 251B.

As illustrated in FIG. 11, the primary and supplementary blanks 201, 203A, 203B may be configured so as to interact in a manner that enables the end supports to be formed easily and quickly as part of the final assembly of the container 200 from a corresponding preassembly (also referred to, for convenience, as preassembly 200). Accordingly, the dimensions for the blanks 201, 203A, 203B and their constituent panels, walls and sections may be selected so as to facilitate the positioning of the supplementary blanks 203A, 203B with respect to the primary blank 201 as illustrated in FIG. 12. The relative dimensions of certain panels of the primary blank 201 and supplementary blanks 203A, 203B are discussed further with reference to FIGS. 13-14.

As shown in FIG. 11, a preassembly may be provided wherein the primary blank 201 and supplementary blanks 203A, 203B are adhered to one another via adhesive but the panels, walls, etc. are not configured for final assembly. As a result, a preassembly 200 (such as that illustrated in FIG. 12) may be manufactured and may be delivered to a location for final assembly and placement of product; such a preassembly may be effectively and easily stacked with other preassemblies because such preassemblies are flat having not yet been built or finally assembled as shown in FIG. 9.

Thus, one or more portions of the primary blank 201 and supplementary blanks 203A, 203B may be adhered to one another, using, for example, adhesive that may be provided on the underside of the attachment panels 247A and 249A of the supplementary blank 203A; likewise adhesive may be provided on the underside of the attachment panels 247B and 249B of the supplementary blank 203B. Thus, when primary blank 201 is brought into contact with the supplementary blanks 203A, 203B, the blanks are joined. It should be understood that this coupling may be made using, for example, adhesive such as glue, staples, tape, etc., so as to produce the preassembly, wherein the positioning of supplementary blanks 203A, 203B in cooperation with primary blank 201 is controlled.

More specifically, and with reference to FIGS. 12-13, the attachment panel 247A is positioned to mate with the first end panel 209 with the outer edge of the attachment panel 247A being positioned offset from but parallel to the fold line 257 between the first back side sub-panel 207A and the first end panel 209. Because of the combined width dimensions of the attachment panel 247A, the offset panel 251A and the major panel 245A, the positioning results in the fold line 243A of the supplementary blank being located past the fold line 258 provided between the first end panel 209 and the front side panel 205 of the primary blank. Thus, the entirety of the attachment panel 249A and the fold line 243A are provided on top of the front panel 205 offset from the fold line 258 of the primary blank. Likewise, attachment panel 247B is positioned to mate with the second end panel 211 with the outer edge of the attachment panel 247B being positioned offset from but parallel to the fold line 259 between the front side panel 205 and the second end panel 211. Because of the combined width dimensions of the attachment panel 247B, the offset panel 251B and the major panel 245B, the positioning results in the fold line 243B of the supplementary blank being located past the fold line 260 provided between the second end panel 211 and the second back side sub-panel 207B of the primary blank. Thus, the entirety of the attachment panel 249B and the fold line 243B are provided on top of the second back side sub-panel 207B offset from the fold line 260 of the primary panel.

As explained in more detail with reference to FIGS. 14-15, the fold lines 241A-B, 243A-B of the supplementary blanks are positioned parallel to but spaced away from corresponding fold lines 257-260 on the primary blank 201 to promote ease of final assembly, increase stacking strength and deter nesting of containers resulting from poor stacking strength.

As shown in FIGS. 12-13, the primary and supplementary blanks may be adhered to each other to form a preassembly 200, where the attachment panels 247A-B, 249A-B of the supplementary blanks meet mating portions of the corresponding panels of the primary blank. More specifically, attachment panel 247A is adhered to the first end panel 209, the attachment panel 249A is adhered to the front side panel 205, the attachment panel 247B is adhered to the second end panel 211 and the attachment panel 249B is adhered to the second back sub-panel 207B.

These panels may be adhered to one another, for example, using adhesive that may be applied to attachment panels 247A-B, 249A-B of each of the supplementary blanks and/or portions of the corresponding panels of the primary blank. Subsequently, the attachment panels 247A-B, 249A-B of each of the supplementary blanks may be placed in contact with corresponding portions of the panels of the primary blank to promote adherence there between. Accordingly, it should be understood that adhesive may be applied on the top surfaces of the side panels of the primary blank or on bottom surfaces of the attachment panels 247A-B, 249A-B of each of the supplementary blanks.

As mentioned above, the fold lines 241A-B, 243A-B of the supplementary blanks are positioned parallel to but spaced away from corresponding fold lines 257-260 on the primary blank 201 to promote ease of final assembly, increase stacking strength and deter nesting of containers resulting from poor stacking strength. Thus, the fold line 241A on a first supplementary blank corresponds to but is positioned apart from the fold line 257 between the first back sub-panel 207A and the first end panel 209. Likewise, the fold line 243A on the first supplementary blank corresponds to but is spaced apart from the fold line 258 between the first end panel 209 and the front side panel 205. Further, fold line 241B on the second supplementary blank corresponds to but is positioned apart from the fold line 259 between the second end panel 211 and the front side panel 205. Likewise, the fold line 243B on the second supplementary blank corresponds to but is spaced apart from the fold line 260 between the front side panel 205 and the second end panel 211. Thus, the fold lines of the supplementary blanks and the corresponding fold lines on the primary blank are positioned parallel to one another but spaced away from each other.

The relationship between the fold lines of the primary and supplementary blanks 201, 203 may be even more clearly understood with reference to FIG. 13. FIG. 13 illustrates the pre-assembly materials for the container of the type illustrated in FIG. 9 during pre-assembly manufacture. The offset of the fold lines of the primary and supplementary blanks enables the preassembly 200 to be flat for shipping to a final assembly location as well as being simply assembled to provide the end supports during final assembly. More specifically, as shown in FIG. 14, as part of preassembly manufacture, the first back sub-panel 207A is folded towards the first end panel 209 along fold line 257. As a result, the optional divider panel 213 (coupled to the first back sub-panel 207A at fold line 255) is carried along towards the front side panel 205. Likewise, the second end panel 211 (not shown but illustrated in FIGS. 12-13) together with the first attachment panel 247B and major panel 245B are folded towards the front side panel 205 along fold line 259. As a result, the second back sub-panel 207B is carried along towards the front side panel 205. To facilitate joining of one end of the optional divider panel 213 to the front side panel 205, adhesive is provided either on the underside of the attachment panels 215 or on a corresponding mating surface on the front side panel 205 (e.g., in a center region of the front side panel 205 and its constituent cross member 223). Although not shown, the first back sub-panel 207A and the divider panel 213 are then positioned to lay flat on top of the corresponding first end panel 209 and first back sub-panel 207A.

Additionally, adhesive is applied to either or both an adhesion region 208A on first back sub-panel 207A or a corresponding adhesion region 208B which is provided on a corresponding mating surface of the second back sub-panel 207B. Thus, once the first back sub-panel 207A is lying flat on top of the first end panel 209 (not shown in FIG. 13), the second back sub-panel 207B is positioned on top of the first back sub-panel 207A but offset in a lateral direction so that the regions 208A and 208B are aligned with one another. As a result of this positioning and affixing of the primary and supplementary blanks described with reference to FIGS. 9-14, a preassembly 200 may be provided which, when utilized, results in a container 200 having an interior formed by the primary blank 201 serving as an exterior of the container 200. The interior includes a plurality of end supports each formed by the supplementary blanks 203A-B and positioned at opposing ends of the container interior, wherein the plurality of end supports are formed as part of the set up or final assembly of exterior of the container 200.

As illustrated in FIG. 15, the resulting container 200 includes the first and second end panels 209, 211, the front side panel 205 and a back side panel formed by the two back side sub-panels 207A-207B. The supplementary blanks adhered to the primary blank provide the end supports on opposing ends of the container 200, wherein each end support is formed by the major panel 245A, 245B, positioned parallel to but spaced apart from their corresponding end panels 211, 209. This offset in positioning deters nesting of the container 200 when the container is used in a stack of containers and being exposed to great vertical force.

The offset of the fold line 241A from the fold line 257 as well as the corresponding offsets provided between fold line pairs (243A, 258), (241B, 259) and (243B, 260) provides the additional utility of enabling improved ease of opening the preassembly to form the container with the end supports. More specifically, when the panels 205, 207A-B, 209, 211 are manipulated to begin formation of the interior of the container 200 there between, the relative dimensions of those panels and those of the supplementary blank panels (245A-B, 247A-B, 249A-B) force the main panels 245A-B to be positioned parallel to the end panels 209, 211, with little or no additional manipulation or force. Thus, it should be appreciated that, the installation of the end supports including the main panels 245A-B may be automatic as a result of the assembly of the panels of the primary blank 201 or it may be facilitated by some minimal additional force.

It should be appreciated that the container design illustrated in FIG. 1 and the container design illustrated in FIG. 9 differ in that the end supports provided in the FIG. 1 embodiment span the full width of the end panels 109, 111 whereas the end supports provided in the FIG. 9 embodiment span the majority of the width of the end panels 209, 211. Therefore, it should be appreciated that both configurations and any end support main panel dimension provided there between is encompassed by the disclosed invention embodiments.

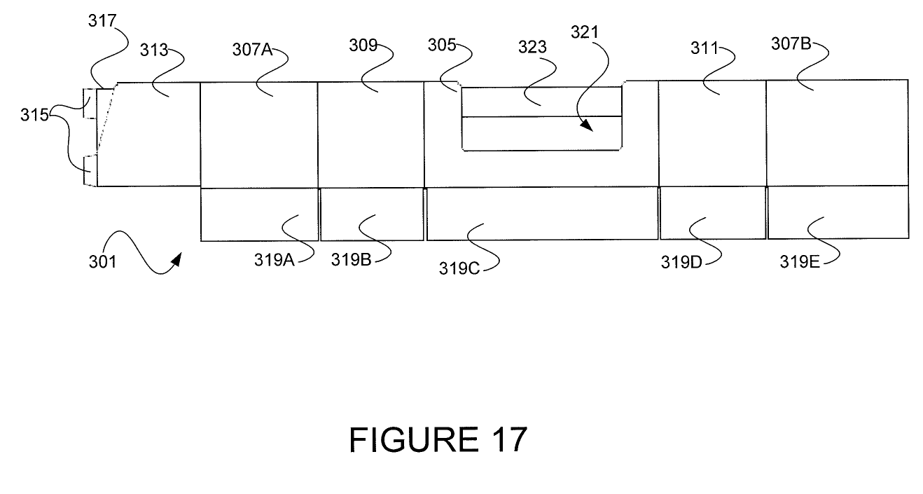

As mentioned above, it should be appreciated that the inventive concept is not limited to the previously disclosed embodiments; rather, various other designs may be provided that include end supports in accordance with the invention embodiments. For example, FIG. 16 illustrates another example of such a container; container 300 is also a slotted bottom tray style container formed by a primary blank 301. The container 300 may include an interior defined between by the side walls of the primary blank 301 and a plurality of end supports formed by a corresponding plurality of supplementary blanks 303 (illustrated in place in the container as 303A-B), included in the interior of the primary blank 301 following assembly. These end supports may be formed by the coupling of the supplementary blanks 303A-B to locations on the primary blank 301, as explained herein. Additionally, as part of preassembly manufacture for a preassembly for container 300, the supplementary blanks 303A-B may be adhered to the primary blank 301 as explained in connection with FIGS. 17-21 to provide for improved ease of final assembly for the container 300.

As shown in FIG. 16, each of the end supports may span a substantial majority of the corresponding end walls of the container 300. Such a container 300 may be used for various purposes including shipping and/or display on a display floor along with other such containers in a stack. However, it should be understood that the manufactured container may be any type of container including, for example, any carton, package, box, etc., of any suitable type; accordingly, the actual configurations of the primary blank 301 and the interrelationship with the supplementary blanks 303A, 303B may change without departing from the scope of the embodiments. Thus, in accordance with illustrated embodiments, a method is provided of manufacturing containers and resulting containers 300 and associated preassemblies (the combination of 301, 303A, 303B) and blanks 301, 303 (supplementary blank 303 being the blank that forms each of 303A, 303B when joined with primary blank 301); when utilized, the method result in containers 300 that include supplementary blanks 303A, 303B that each provide an end support that serves as a mechanism for improving the stackability of the container 300, whereby the container 300 may be configured to bare larger amounts of force (e.g., weight) from a top direction.

FIG. 17 illustrates an example of a primary blank 301, which may be thought of as a conventional tray type as the one illustrated in FIG. 1. It should be appreciated that the primary blank 301 is identical to primary blank 101 illustrated in FIG. 2 except with an alteration in the reference numerals, i.e., front panel 105 corresponds with front panel 305. Therefore, further description of the primary blank 301 is omitted.

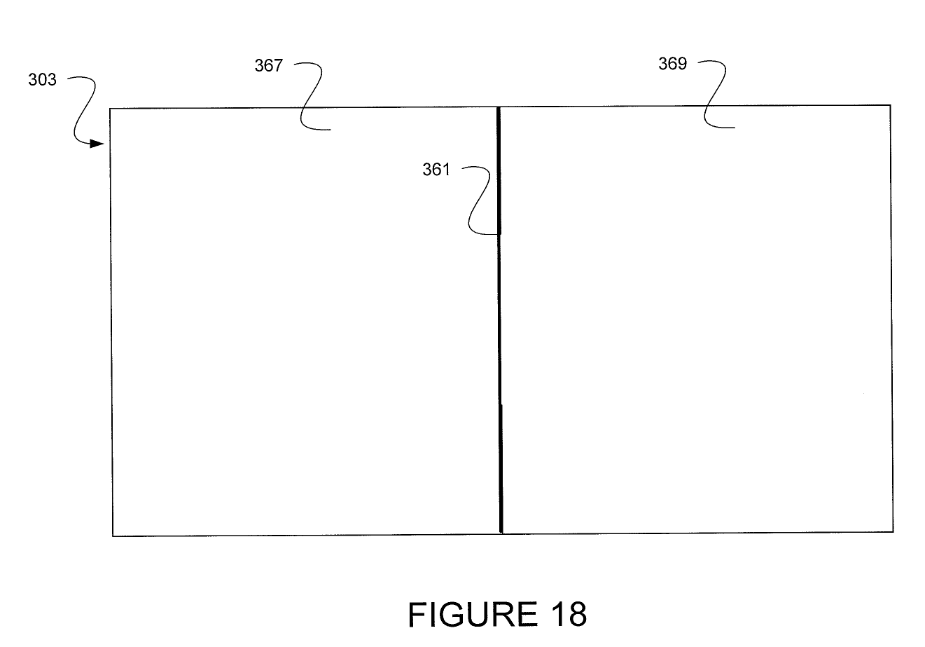

FIG. 18 illustrates an example of a supplementary blank 303 that differs in configuration from the supplementary blank 103 illustrated in FIG. 2 and supplementary blank 203 of FIG. 11. As shown in FIG. 18, the supplementary blank 303 includes two sub-panels 36, 369 that share a fold line 361.

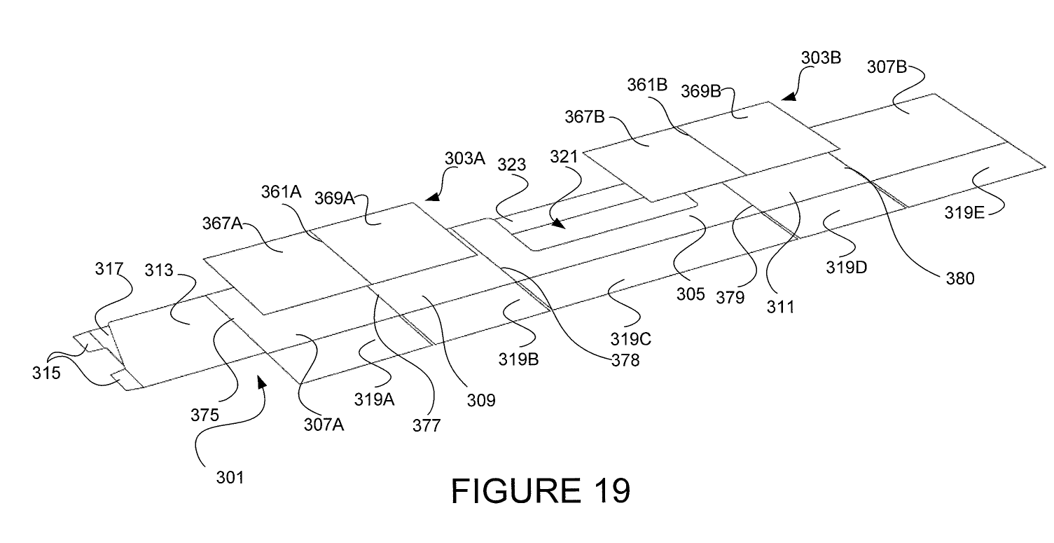

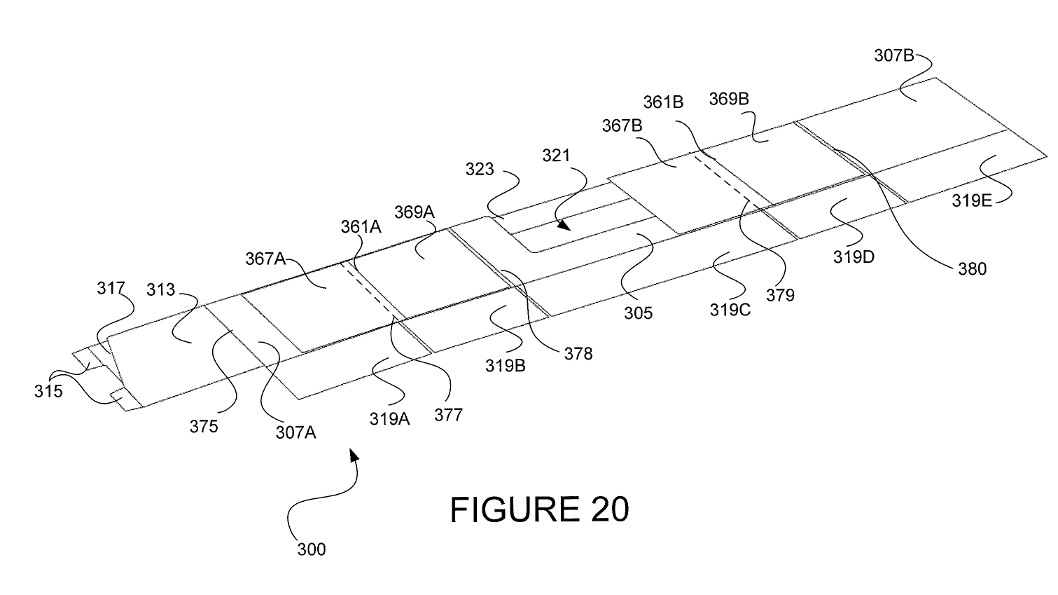

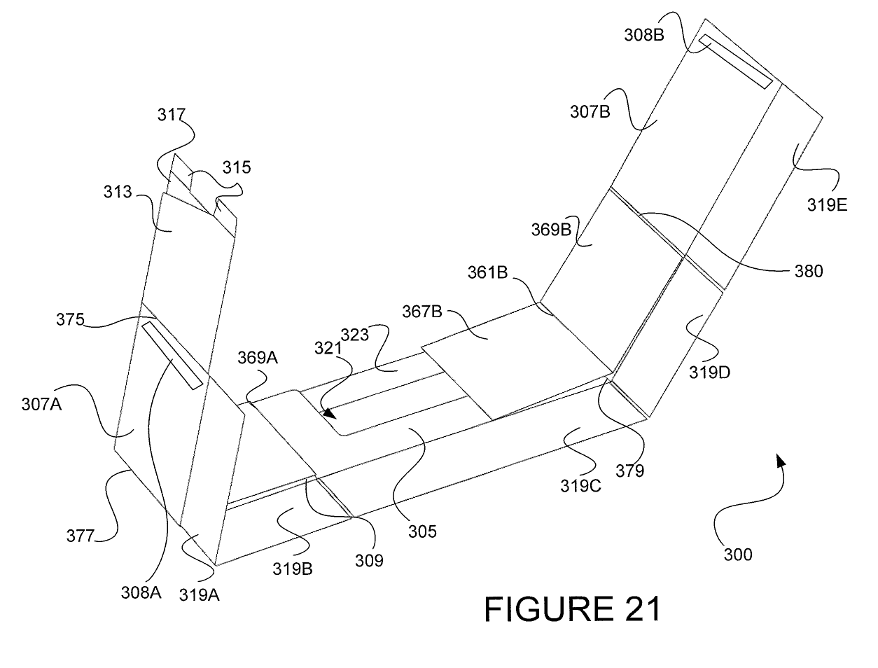

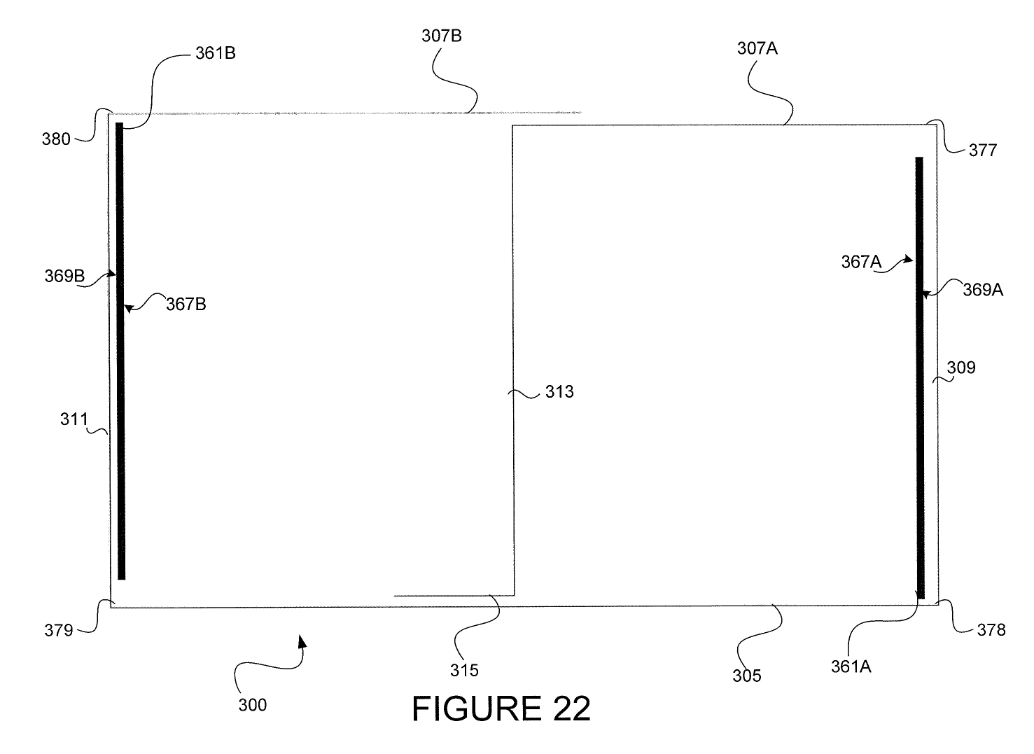

FIG. 19 illustrates the relative placement of the primary blank 301 and supplementary blanks 303 illustrated in FIGS. 17 and 18 with respect to each other to provide a preassembly as illustrated in FIGS. 20-21 and the container illustrated in FIGS. 16 and 22. It should be understood that the supplementary blank 303 illustrated in FIG. 18 is the same blank as 303A and 303B illustrated in FIGS. 16 and 19-22 but is labeled as such for ease of description. Thus, where a blank 303 (illustrated in FIG. 18) includes sub-panels 367 and 369, the supplementary blank 303A (illustrated in FIGS. 19-22) includes sub-panels 367A, 369A; likewise the supplementary blank 303B (illustrated in FIGS. 19-22) includes sub-panels 267B, 369B.

As illustrated in FIG. 19, the primary and supplementary blanks 301, 303A, 303B may be configured so as to interact in a manner that enables the end supports to be formed easily and quickly as part of the preassembly manufacture for the container 300. Accordingly, the dimensions for the blanks 301, 303A, 303B and their constituent panels, walls and sections may be selected so as to facilitate the positioning of the supplementary blanks 303A, 303B with respect to the primary blank 301 as illustrated in FIG. 20. The relative dimensions of certain panels of the primary blank 301 and supplementary blanks 303A, 303B are discussed further with reference to FIGS. 20-21.

As shown in FIGS. 19-20, a preassembly may be provided wherein the primary blank 301 and supplementary blanks 303A, 303B are adhered to one another via adhesive but the panels, walls, etc. are not configured for final assembly. As a result, a preassembly 300 (such as that illustrated in FIG. 20) may be manufactured and may be delivered to a location for final assembly and placement of product; such a preassembly may be effectively and easily stacked with other preassemblies because such preassemblies are flat having not yet been built or finally assembled as shown in FIG. 16.

Thus, one or more portions of the primary blank 301 and supplementary blanks 303A, 303B may be adhered to one another, using, for example, adhesive that may be provided on the underside of one of the sub-panels, while adhesive may be applied to the upper side of the other of the sub-panels. For example, adhesive may be applied to the under side of sub-panel 369A of supplementary blank 303A to adhere the sub-panel 369A to the first end panel 309. Likewise, adhesive may be applied to the under side of sub-panel 369B to adhere the sub-panel 369B to the second end panel 311. Thus, when primary blank 301 is brought into contact with the supplementary blanks 303A, 303B, the blanks are joined. It should be understood that this coupling may be made using, for example, adhesive such as glue, staples, tape, etc., so as to produce the preassembly, wherein the positioning of supplementary blanks 303A, 303B in cooperation with primary blank 301 is controlled.

More specifically, and with reference to FIGS. 19-20, the first sub-panel 369A is positioned to mate with the first end panel 309 with the outer edge of the attachment panel 369A being positioned next to but parallel to the fold line 378 between the first end panel 309 and the front side panel 305. Because of the width dimension of the sub-panel 369A, the fold line 361A does not line up with the fold line 377 between the first back sub-panel 307A and the first end panel 309. Likewise, the first sub-panel 369B is positioned to mate with the second end panel 311 with the outer edge of the attachment panel 369B being positioned next to but parallel to the fold line 380 between the second end panel 311 and the second back side panel 307B. Because of the width dimension of the sub-panel 369B, the fold line 361B does not line up with the fold line 379 between the front side panel 305 and the second end panel 311.

However, unlike other illustrated embodiments, the supplementary blanks 303A, 303B may not be adhered to the primary blank at multiple, separate locations. Rather, at least in the illustrated embodiment of FIGS. 16-22, adhesive is also applied to the upper side of sub-panel 367A for the purpose of adhering that upper side of sub-panel 367A to the upper side of sub-panel 369A as the panels of the primary blank 301 are folded towards themselves during preassembly manufacture (as explained with reference to FIG. 21). Likewise, adhesive is applied to the upper side of the sub-panel 367B for the purpose of adhering the upper side of sub-panel 367B to the upper side of sub-panel 369B as the panels of the primary blank 301 are folded towards themselves during preassembly manufacture.

Thus, as shown in FIG. 20-21, the fold lines 361A-B do not line up with the corresponding fold lines 377, 379. This offset relationship between the fold lines of the primary and supplementary blanks 301, 303 promotes the folding of the first sub-panels 367A-B towards the second sub-panels 369A-B as shown in FIG. 21. Thus, as the first back sub-panel 307A is folded towards the first end panel 309 along fold line 377 and the optional divider panel 213 (coupled to the first back sub-panel 307A at fold line 375) is carried along towards the front side panel 305, the sub-panel 367A is folded towards the sub-panel 369A along fold line 361A and the adhesive provided on the upper side of sub-panels 367A adheres the sub-panels 367A, 369A together. Likewise, as the second end panel 311 (not shown but illustrated in FIGS. 19-20) is folded towards the front side panel 305 along fold line 379, the second sub-panel 369B is folded towards the first sub-panel 367B along fold line 361B. Subsequently, the adhesive provided on the upper side of sub-panels 367B adheres the sub-panels 367B, 369B together.

However, it should be appreciated that adhesive or other material joining the panels of the primary and supplementary blanks may be provided on one or both mating surfaces and may be provided on a different surface than described. For example, adhesive may be applied to both sides of the second sub-panels 369A-B of the supplementary blank rather than providing adhesive on one side mating with the corresponding end panel and providing adhesive on one side of the first sub-panels 367A-B.

As in other illustrated embodiments, however, the second back sub-panel 307B is carried along towards the front side panel 305 as the panels are folded in on themselves to produce the preassembly. Accordingly, as in other illustrated embodiments, one end of the optional divider panel 313 may be joined to the front side panel 305 by adhesive provided either on the underside of the attachment panels 315 or on a corresponding mating surface on the front side panel 305 (e.g., in a center region of the front side panel 305 and its constituent cross member 323). Although not shown, the first back sub-panel 307A and the divider panel 313 are then positioned to lay flat on top of the corresponding first end panel 309 and first back sub-panel 307A.

Additionally, adhesive is applied to either or both an adhesion region 308A on first back sub-panel 307A or a corresponding adhesion region 308B, which is provided on a corresponding mating surface of the second back sub-panel 307B. Thus, once the first back sub-panel 307A is lying flat on top of the first end panel 309 (not shown in FIG. 21), the second back sub-panel 307B is positioned on top of the first back sub-panel 307A but offset in a lateral direction so that the regions 308A and 308B are aligned with one another. As a result of this positioning and affixing of the primary and supplementary blanks described with reference to FIGS. 16-21, a preassembly 300 may be provided which, when utilized, results in a container 300 having an interior formed by the primary blank 301 serving as an exterior of the container 300. The interior includes a plurality of end supports each formed by the supplementary blanks 303A-B and positioned at opposing ends of the container interior, wherein the plurality of end supports are formed as part of the set up or final assembly of exterior of the container 300.

As illustrated in FIG. 22, the resulting container 300 includes the first and second end panels 309, 311, the front side panel 305 and a back side panel formed by the two back side sub-panels 307A-307B. The supplementary blanks adhered to the primary blank provide the end supports on opposing ends of the container 300, wherein each end support is formed by the combination of the sub-panels 367, 369 adhered to one another. The sub-panel combination is adhered to the corresponding end panel. Thus, the combination 367A, 369A is adhered to first end panel 309. Likewise, the combination 367B, 369B is adhered to second end panel 311.

It should be appreciated that the container design illustrated in FIG. 16 and the container designs illustrated in FIGS. 1 and 9 differ in that the end supports provided in each of the figures have varying width spans relative to the widths of the corresponding end panels. Therefore, it should be appreciated that end supports of various dimensions are encompassed by the disclosed invention embodiments.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, various illustrated features of the preassembly and resulting containers may be omitted. Furthermore, it should be understood that invention embodiments are capable of variations practiced or carried out in various ways. Therefore, it should be appreciated that, in accordance with at least one embodiment of the invention, any and all of the walls may be constructed of corrugated cardboard. However, it should be understood that the walls, panels, any tabs on various panels, etc., may be constructed of various industry recognized appropriate materials that meet various transporting and/or display criteria. As a result, it should be understood that containers manufactured in accordance with at least one embodiment of the invention may also be considered “cartons,” which may be considered packaging or display containers, commonly made from cardstock or cardboard. Further, it should be understood that cartons come in many different varieties but most cartons can be folded and assembled from a flat form, known as a carton blank. Thus, it should be understood that the pattern for any blank, preassembly or container may be different than those described herein.

Alternatively, or more specifically, the packaging and/or display containers may be made using corrugated board, e.g., material made by a corrugator (a machine that produces corrugated board by attaching fluting to liners) which is a structured board formed by gluing one or more arched layers of corrugated medium to one or more flat-facing linerboards.

Additionally, it should be appreciated that material used in accordance with at least one embodiment of the invention may be laminated to provide barrier properties. Further, other barrier materials may be used including Ultra Violet (UV), moisture and gas barriers. Additionally, though not discussed in detail herein, it should be understood that any adhesive used to provide a bond between materials used in containers provided in accordance with the invention may include any substance that helps bond two materials together, examples including but not limited to glue and paste.

Further, it should be appreciated that the material used to form the primary blank may be different, stronger, or weaker than the blank used to form the supplementary blank. Thus, for example, use of a supplementary blank that is of a heavier, more durable or stronger material than the material used for primary blank, may provide the increased ease of final assembly as well as increased durability or strength to the resulting container while reducing the amount of material in the container (something of interest for environmental and cost issues).

It should be understood that implementation of the method and system of the present invention involves performing or completing certain selected tasks or steps manually, automatically, or a combination thereof.

It should also be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Additionally, it should be understood that the functionality described in connection with various described components of various invention embodiments may be combined or separated from one another in such a way that the structure of the invention is somewhat different than what is expressly disclosed herein.

Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

As a result, it will be apparent for those skilled in the art that the illustrative embodiments described are only examples and that various modifications can be made within the scope of the invention as defined in the appended claims.

1. A method of manufacturing a container, the method comprising:
cutting a primary blank including a plurality of side panels and end panels configured to provide an exterior of the container;
cutting a plurality of supplementary blanks each including a plurality of panels; and
affixing at least one of the panels of each of the supplementary blanks to a side panel and either an adjacent end panel or an opposing side panel of the primary blank such that, as the primary blank panels are manipulated to form the exterior of the container, each of a plurality of end supports is formed proximate to a corresponding end panel of the primary blank when the side panels corresponding to that end panel are folded relative to that end panel,
wherein, following final assembly, the plurality of panels of each supplementary blank constitute the end support proximate to the corresponding end panel and at least one panel of the plurality of panels of each supplementary blank is positioned parallel to but spaced apart from a corresponding end panel.

2. The method of claim 1, wherein the plurality of supplementary blank panels includes a main panel and a plurality of attachment panels and the supplementary blank is affixed to the primary blank at the plurality of attachment panels.

3. The method of claim 2, wherein one of the attachment panels is affixed to a side panel of the primary blank and one of the attachment panels is affixed to an adjacent end panel of the primary blank.

4. The method of claim 3, wherein the main panel of the supplementary blank has a width equal to the width of the corresponding end panel of the primary blank.

5. The method of claim 2, wherein one of the attachment panels is affixed to a side panel of the primary blank and one of the attachment panels is affixed to an opposing side panel of the primary blank.

6. The method of claim 2, wherein the main panel of the supplementary blank has a width less than the width of the corresponding end panel of the primary blank.

7. The method of claim 6, wherein the main panel of the supplementary blank has a width more than half the width of the corresponding end panel of the primary blank.

8. The method of claim 1, wherein the container is a slotted bottomed tray container.

9. A method of manufacturing a container, the method comprising:
cutting a primary blank including a plurality of side panels and end panels configured to provide an exterior of the container;
cutting first and second supplementary blanks each including a plurality of panels; and
affixing a first panel of the first supplementary blank to a corresponding end panel of the primary blank;
affixing a first panel of the second supplementary blank to a corresponding end panel of the primary blank;
folding at least one panel of the primary blank towards another panel of the primary blank, wherein the folding causes a second panel of the first supplementary blank to fold towards another panel of the first supplementary blank such that adhesive carried on one or both of the first and second panels to affix the first and second panels of the first supplementary blank together, and
folding at least one other panel of the primary blank towards another panel of the primary blank, wherein the folding causes a second panel of the second supplementary blank to fold towards another panel of the second supplementary blank such that adhesive carried on one or both of the first and second panels affixes the first and second panels of second supplementary blank together.

10. The method of claim 9, wherein the plurality of supplementary blank panels includes two equally sized panels.

11. The method of claim 9, wherein the container is a slotted bottomed tray container.

12. A container preassembly comprising:
a primary blank including a plurality of side panels and end panels configured to provide an exterior of the container; and
a plurality of supplementary blanks each including a plurality of major panels extending between a pair of attachment panels,
wherein at least one of the attachment panels of each of the supplementary blanks is affixed to a side panel and either an adjacent end panel or an opposing side panel of the primary blank such that, as the primary blank panels are manipulated to form an exterior of the container, each of a plurality of end supports is formed proximate to a corresponding end panel of the primary blank when the side panels corresponding to that end panel are folded relative to that end panel,
wherein, following final assembly, the plurality of major panels of each supplementary blank constitute the end support proximate to the corresponding end panel and at least one panel of the plurality of major panels of each supplementary blank is positioned parallel to but spaced apart from a corresponding end panel.

13. The preassembly of claim 12, wherein one of the attachment panels is affixed to a side panel of the primary blank and one of the attachment panels is affixed to an adjacent end panel of the primary blank.

14. The preassembly of claim 13, wherein the main panel of the supplementary blank has a width less than the width of the corresponding end panel of the primary blank.

15. The preassembly of claim 12, wherein one of the attachment panels is affixed to a side panel of the primary blank and one of the attachment panels is affixed to an opposing side panel of the primary blank.

16. The preassembly of claim 12, wherein the main panel of the supplementary blank has a width equal to the width of the corresponding end panel of the primary blank.

17. The preassembly of claim 16, wherein the main panel of the supplementary blank has a width more than half the width of the corresponding end panel of the primary blank.

18. The preassembly of claim 12, wherein the container is a slotted bottomed tray container.

19. A container preassembly comprising:
a primary blank including a plurality of side panels and end panels configured to provide an exterior of the container; and
first and second supplementary blanks each including a plurality of panels;
wherein the first panel of the first supplementary blank is affixed to a corresponding end panel of the primary blank in a manner such that when at least one panel of the primary blank is folded towards another panel of the primary blank, the folding causes a second panel of the first supplementary blank to fold towards another panel of the first supplementary blank such that adhesive carried on one or both of the first and second panels to affix the first and second panels of the first supplementary blank together, and
wherein the first panel of the second supplementary blank is affixed to a corresponding end panel of the primary blank in a manner such that when at least one other panel of the primary blank is folded towards another panel of the primary blank, the folding causes a second panel of the second supplementary blank to fold towards another panel of the second supplementary blank such that adhesive carried on one or both of the first and second panels to affix the first and second panels of the second supplementary blank together.

20. The preassembly of claim 19, wherein the plurality of supplementary blank panels includes two equally sized panels.

21. The preassembly of claim 20 wherein a first panel of the second supplementary blank is affixed to a corresponding end panel of the primary blank such that, when at least one panel of the primary blank is folded towards another panel of the primary blank, the folding causes a second panel of the second supplementary blank to fold towards another panel of the second supplementary blank such that adhesive carried on one or both of the first and second panels to affix the first and second panels together.

22. The preassembly of claim 19, wherein the container is a slotted bottomed tray container.

23. A plurality of blanks for a container preassembly, the plurality of blanks comprising:
a primary blank including a plurality of side panels and end panels configured to provide an exterior of the container; and
a plurality of supplementary blanks each including a plurality of major panels extending between a pair of attachment panels,
wherein the secondary blanks are configured to mate with and be affixed with the primary blank so that, when affixed together, each of the supplementary blanks is affixed to a side panel and either an adjacent end panel or an opposing side panel of the primary blank such that, as the primary blank panels are manipulated to form an exterior of the container, each of a plurality of end supports is formed proximate to a corresponding end panel of the primary blank when the side panels corresponding to that end panel are folded relative to that end panel, and
wherein, following final assembly, the plurality of panels of each supplementary blank will constitute the end support proximate to the corresponding end panel and at least one panel of the plurality of panels of each supplementary blank is positioned parallel to but spaced apart from a corresponding end panel.

24. The plurality of blanks of claim 23, wherein the main panel of the supplementary blank has a width equal to the width of the corresponding end panel of the primary blank.

25. The plurality of blanks of claim 23, wherein the main panel of the supplementary blank has a width less than the width of the corresponding end panel of the primary blank.

26. The plurality of blanks of claim 26, wherein the main panel of the supplementary blank has a width more than half the width of the corresponding end panel of the primary blank.

27. The plurality of blanks of claim 23, wherein the container is a slotted bottomed tray container.

28. A plurality of blanks for a container preassembly, the plurality of blanks comprising:
a primary blank including a plurality of side panels and end panels configured to provide an exterior of the container; and
first and second supplementary blanks each including a plurality of panels,
wherein the first supplementary blank is configured to mate with and be affixed with the primary blank so that when at least one panel of the primary blank is folded towards another panel of the primary blank, the folding causes a second panel of the first supplementary blank to fold towards another panel of the first supplementary blank such that adhesive carried on one or both of the first and second panels to affix the first and second panels of the first supplementary blank together, and
wherein the second supplementary blank is configured to mate with and be affixed with the primary blank so that when at least one other panel of the primary blank is folded towards another panel of the primary blank, the folding causes a second panel of the second supplementary blank to fold towards another panel of the second supplementary blank such that adhesive carried on one or both of the first and second panels to affix the first and second panels of the second supplementary blank together.

29. The plurality of blanks of claim 28, wherein the plurality of supplementary blank panels includes two equally sized panels.

30. The plurality of blanks of claim 28 wherein a first panel of the second supplementary blank is affixed to a corresponding end panel of the primary blank such that, when at least one panel of the primary blank is folded towards another panel of the primary blank, the folding causes a second panel of the second supplementary blank to fold towards another panel of the second supplementary blank such that adhesive carried on one or both of the first and second panels to affix the first and second panels together.

31. The plurality of blanks of claim 28, wherein the container is a slotted bottomed tray container.
